(19) United States
(12) Patent Application Publication
(10) Pub. No.: US 2014/0354064 A1
(43) Pub. Date: Dec. 4, 2014

(54) SYSTEM AND METHOD FOR SAFE, WIRELESS ENERGY TRANSMISSION

(71) Applicant: Dmitriy Tseliakhovich, Broomfield, CO (US)

(72) Inventor: Dmitriy Tseliakhovich, Broomfield, CO (US)

(73) Assignee: ESCAPE DYNAMICS, INC., Broomfield, CO (US)

(21) Appl. No.: 14/268,715

(22) Filed: May 2, 2014

Related U.S. Application Data
(60) Provisional application No. 61/828,496, filed on May 29, 2013.

(51) Int. Cl. H02J 17/00

(52) U.S. Cl. CPC H02J 17/00
USPC 307/104

(57) ABSTRACT

A system for transmitting energy comprises a controller operably coupled to a plurality of energy transmitters. Each of the transmitters comprises a microwave generator, a waveguide positioned for receiving the beam of electromagnetic energy from the microwave generator, an antenna positioned for receiving the guided beam of electromagnetic energy, and a radome disposed about the antenna. The microwave generator is configured for emitting a beam of electromagnetic energy. The waveguide is configured for receiving the beam of electromagnetic energy and emitting a guided beam of electromagnetic energy. The antenna is configured for forming a directional beam of microwave energy with a controlled phase, and the directional beam of microwave energy has controlled energy distribution properties. The controller is configured for modulating at least one attribute of the directional beam of microwave energy of each energy transmitter of the plurality of energy transmitters.

### CROSS-REFERENCE TO RELATED APPLICATIONS

This patent application claims priority to U.S. Provisional Patent Application Ser. No. 61/828,496 filed May 29, 2013, which is incorporated herein by reference in its entirety.

### BACKGROUND OF THE INVENTION

The present invention relates to systems and methods for wirelessly transmitting energy and more particularly to an improved system and method for wirelessly transmitting energy including a microwave generator, a waveguide, an antenna, and a radome disposed about an antenna.

The utility of wireless transmission of electromagnetic energy has been recognized for many potential applications including providing a source of power to remotely located objects such as an aerial vehicle. Unfortunately, a number of challenges have also been identified in regard to wireless energy transmission. For example, the magnitude of energy to be transmitted in many currently envisioned applications tends to exacerbate the importance of safety, reliability, and efficiency in the design of any practical system. At the same time, the ability to focus and aim an energy beam at a target with continuous and reliable precision is also very important. The requirement for precision in aiming the energy beam can be particularly challenging in the presence of environmental factors such as wind and vibration. Other problems include the inherent production of energy transmission lobes along sides of a transmitting antenna. Such side lobes may be undesirable for a number of reasons including safety and interference with other transmissions.

A number of attempts have been made to provide power to aerial vehicles using laser beam energy. Others have attempted to facilitate vehicle propulsion using s-band microwave antennas. To date, however, practical, safe, scalable and affordable operation of wirelessly powered aerial vehicles has not been achieved.

Accordingly, it is desirable to have a practical system and method for providing wireless energy transmission with improved safety, efficiency, and reliability. It would also be desirable to have an improved system and method for powering aerial vehicles with electromagnetic energy. It would also be desirable to have an improved system and method for transmitting energy wirelessly to a moving aerial vehicle in a safe, reliable and highly efficient way. Still further, it would be desirable to have a system and method that would enable efficient and reliable steering of microwave antennas while reducing vibrations associated with wind and other environmental factors. Finally, it would be desirable to have a system and method that addresses safety concerns related to operation of wireless energy transfer systems and techniques.

### SUMMARY OF THE INVENTION

In an exemplary embodiment, a system for transmitting energy comprises a controller operably coupled to a plurality of energy transmitters. Each of the plurality of energy transmitters comprises a microwave generator coupled to a source of electrical energy, a waveguide positioned for receiving the beam of electromagnetic energy from the microwave generator, an antenna positioned for receiving the guided beam of electromagnetic energy, and a radome disposed about the antenna. The microwave generator is configured for receiving electrical energy from the source of electrical energy and emitting a beam of electromagnetic energy. The waveguide is configured for receiving the beam of electromagnetic energy and emitting a guided beam of electromagnetic energy. The antenna is configured for forming a directional beam of microwave energy. The directional beam of microwave energy has a controlled phase, and the directional beam of microwave energy has controlled energy distribution properties. The controller is configured for modulating at least one attribute of the directional beam of microwave energy of each energy transmitter of the plurality of energy transmitters.

In another aspect, an exemplary method for transmitting energy includes receiving, by a plurality of microwave generators, electrical energy and emitting a beam of electromagnetic energy. Each of the plurality of microwave generators is associated with a respective energy transmitter. The method also includes receiving, by a waveguide or a system of wave-guiding mirrors, the beam of electromagnetic energy and emitting a guided beam of electromagnetic energy. In addition, the method includes receiving, by an antenna, the guided beam of electromagnetic energy and emitting, by the antenna, within a radome, a directional beam of microwave energy. The directional beam of microwave energy has a controlled attribute related to a phase and a controlled energy distribution property of the directional beam of microwave energy. Further still, the method includes absorbing energy from side lobes of the emitting antenna in the radome as to avoid undesired microwave radiation, protecting microwave antenna with the radome, and modulating at least one attribute of the directional beam of microwave energy of each energy transmitter of the plurality of energy transmitters.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 2 is a diagrammatic view of an exemplary system comprising a microwave emitter, beam-guiding system of mirrors, gimbal, antenna and side-lobe suppressing radome;

FIG. 3 shows an exemplary embodiment of a side-lobe suppressing radome with cameras which allow detection of extraneous objects moving in the direction of the electromagnetic beam;

FIG. 5 is a simplified schematic of an operational wireless energy transfer system for powering moving aerial vehicles flying over buildings;

FIG. 4 depicts the difference between beam pattern of a typical antenna and an antenna enclosed in a side-lobe suppressing radome;

FIG. 6 a simplified schematic of an operational wireless energy transfer system designed to power moving aerial vehicles from mobile platforms, like a truck or a several trucks;

FIG. 7 shows one possible implementation of an antenna comprised of multiple small mirrors and a movable secondary mirror used to control phase of the beam through path-length adjustment and adjustment of the geometry of the primary mirror;

FIG. 8 shows a possible implementation of a side-lobe suppressing radome with an electromagnetically active structure installed in the path of the main lobe of the energy beam; and

FIG. 1 shows one possible implementation of a phased array in which all of the elements of the array are connected to a central controller station and to a central energy station.

It is expressly understood that the invention as defined by the claims may be broader than the embodiments illustrated in the Figures and described in the detailed description section below.

### DETAILED DESCRIPTION

In an exemplary embodiment, a system for transmitting energy comprises a controller operably coupled to a plurality of energy transmitters. Each energy transmitter comprises a microwave generator coupled to a source of electrical energy. The microwave generator is configured for receiving electrical energy from the source of electrical energy and emitting a beam of electromagnetic energy. In one exemplary embodiment, energy from electric grid is received by a gyrotron, and a beam of millimeter waves is emitted from the gyrotron.

Electricity from the electric grid may be received in a form of 3 phase AC current at fixed nominal voltage (e.g., 480V) and may be converted through a dedicated power supply source into a high voltage DC current before entering the microwave generator, which may comprise a gyrotron. In another exemplary embodiment, the source of energy is an electrical generator which provides either AC or DC electric current to the microwave generator. It should be appreciated that the source of energy could also be a battery, a system of batteries arranged in a battery pack, a fuel cell, or a system of fuel cells.

A waveguide, which may comprise a system of mirrors, is positioned for receiving the beam of electromagnetic energy from the microwave generator. The waveguide (i.e., the system of wave-guiding mirrors) is configured for receiving the beam of electromagnetic energy and emitting a guided beam of electromagnetic energy into an antenna. A waveguide or a system of wave-directing mirrors can be positioned inside of a gimbal unit configured for steering of an antenna. A waveguide, or a system of wave-directing mirrors, can be configured to provide a controlled variation of the beam path allowing for control of a phase of electromagnetic energy 6 that is emitted into an antenna.

An antenna is positioned and configured for receiving the guided beam of electromagnetic energy. The antenna is also configured for forming a directional beam of microwave energy having a controlled phase and controlled energy distribution properties. The antenna can be a Cassegrain antenna with a parabolic dish as the primary mirror, or with a parabolic trough as the primary mirror, or any other type of antenna configured for directional energy transfer. An antenna can be configured in such a way as to allow control of the phase of the electromagnetic energy by adjusting geometric properties of the antenna. For example, a primary reflector could be made of multiple mirrors each with independent precise actuator. As another example, the secondary mirror of an antenna could be configured to move in one, two, or three dimensions to facilitate precise control over of the path length of the electromagnetic beam so as to enable control of the phase of the beam.

A radome may be disposed about the antenna. A radome is configured to suppress the side lobes. A radome can be also configured to serve as a lens for the main beam. A radome could be configured to move in conjunction with the antenna as the antenna is steered by a gimbal system. A radome could include a system of optical and/or IR cameras to provide video of the surrounding area of a transmitter. Alternatively, a camera or a system of cameras could be located outside of a radome. The controller is configured for modulating at least one attribute of the directional beam of microwave energy of each energy transmitter of the plurality of energy transmitters. The controller is configured to receive and interpret the feed from a camera or system of cameras. The controller could be configured to terminate the beam if an extraneous object enters the area of an active beam as detected by a camera or system of cameras. The controller could be configured to receive information from a moving aerial vehicle about the position, orientation and motion of the vehicle and use that information to compute optimal parameters of the beam from each transmitter in the phased array so as to provide desired energy to the aerial vehicle.

A method for transmitting energy comprises receiving, by a plurality of microwave generators, each microwave generator being associated with a respective energy transmitter, electrical energy and emitting a beam of electromagnetic energy. The method also comprises receiving, by a waveguide or a system of wave-directing mirrors, the beam of electromagnetic energy and emitting a guided beam of electromagnetic energy into an antenna. The method includes control of the phase of the beam entering into antenna by adjusting the path-length of beam travelling through a waveguide or a system of wave-directing mirrors. The method further includes receiving, by an antenna, the guided beam of electromagnetic energy and emitting, also by the antenna, and within a radome, a directional beam of microwave energy, with the directional beam of microwave energy having a controlled attribute related to a phase and a controlled energy distribution property of the directional beam of microwave energy.

The method also includes suppression of side lobes from an antenna by a radome to ensure elimination of energy flow in undesired direction. A method could include observation of environment in the direction of the energy beam with optical or infrared cameras, which are connected to a control system and are configured to detect undesired objects entering the vicinity of the energy beam. The method also includes modulating at least one attribute of the directional beam of microwave energy of each energy transmitter of the plurality of energy transmitters. The method may also include combining energy beams from multiple transmitters in such a way as to provide high energy density at a receiving object and low energy density at other locations. The method may also include communicating, via a wireless link, between a controller, operably coupled to a plurality of energy transmitters, and a moving aerial vehicle configured for receiving energy from the system of energy transmitter and capable of communicating its position and orientation to the controller.

It must be appreciated that in some applications, one energy transmitter could be employed. In this case the key benefit of the invention comes from the suppression of side lobe radiation with a side-lobe suppressing radome.

It must be appreciated that the position of a moving aerial vehicle can be determined in a plurality of ways, one including the use of on-board sensors (e.g., sonar, lidar, gps, etc.) and the use of cameras located on the ground or incorporated into the radomes of energy transmitters. It should be appreciated that position, orientation, and motion (i.e., a velocity vector) of the aerial vehicle can be determined with a reliable level of precision, and such information can be communicated to the controller of the energy transmitting array, which is configured for determining optimal parameters for energy transmission and for modulating at least one attribute of the directional beam of microwave energy of each energy transmitter of the plurality of energy transmitters.

In an exemplary embodiment, the method includes combining, at a designated point in space where beams may combine coherently and where energy may be maximized so as to provide useful energy to a receiving object such as an aerial vehicle, beams from multiple energy transmitters. The method allows controlling a set of energy transmitter via both mechanical steering of antennas and phase adjustment to move the location of the energy maximum so as to follow a moving receiver.

In an exemplary embodiment, the method includes combining, at a designated point in space where beams may combine coherently and where energy may be maximized so as to provide useful energy to a receiving object, such as an aerial vehicle, beams from multiple energy transmitters separated by a distance of several meters and potentially on separate roof tops, separate towers on the border, and/or separate mobile platforms (e.g., trucks, naval vessels, etc.). The method in this embodiment includes control of each transmitter from a central controller in such a way as to allow desired energy density and distribution to be maintained on a receiving object—even if one of the transmitters is terminated. The control of each transmitter may facilitate control of the phase of the beam, energy density of the beam and/or precise direction of the beam. The method in this embodiment provides redundancy and ensures safety of operation. For example, if there is a bird flying into the field of view of one of the transmitters, the beam of that transmitter is turned off and the energy density and phases of other beams are recomputed to maintain the desired energy density and focusing on the receiving object.

Referring now to the Figures, where the invention will be described with reference to specific embodiments, without limiting same, an exemplary system for transmitting energy comprises a controller 97 operably coupled to a plurality of energy transmitters 24. The controller 97 can be connected to each individual transmitter wirelessly or via a wired connection 92. The controller 97 may also be a distributed controller 97 as described later in this disclosure. In accordance with such a system, each energy transmitter comprises a microwave generator 16 (e.g., a gyrotron, a klystron, or any other suitable apparatus capable of generating microwave energy 53) coupled to a source of electrical energy (e.g. an electric grid 99, a generator, a battery, a fuel cell, etc.) through a power supply system 10 capable of outputting electrical energy compatible with the input requirement of the microwave generator 16. The source of energy could be connected to the power supply system 10 of each transmitter via a system of cables 84 as in case of an electric grid 99 or could be directly integrated into the energy transmitting unit as could be beneficial in case of mobile application where a battery, a fuel cell, and/or a generator are used. The microwave generator 16 is configured for receiving electrical energy from the power supply system 10, converting the electrical energy to electromagnetic energy 6, and emitting the electromagnetic energy 6 in the form of a beam (i.e., a beam of electromagnetic energy) 6, which may be directed via a waveguide, that may comprise a system of beam-guiding mirrors, into the antenna 57. Thus, the waveguide is configured for leading the beam into the antenna 57. The source of electrical energy may be an electric grid 99, a generator, a system of batteries or any other energy storage/generation device. In an exemplary embodiment, the beam of electromagnetic energy 6 produced by each energy transmitter is transmitted so as to exhibit a controlled frequency and a controlled beam pattern.

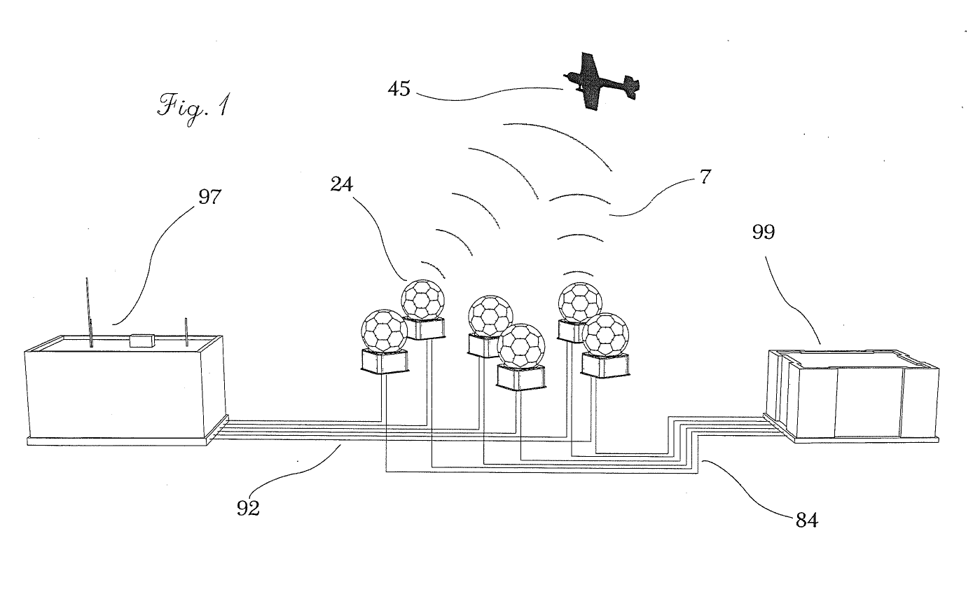

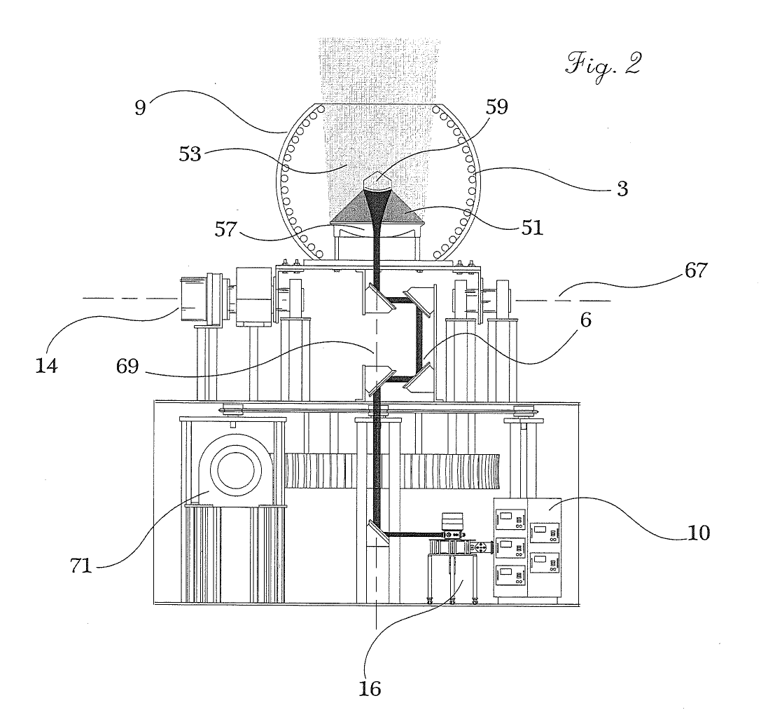

Each energy transmitter also comprises a waveguide or a system of wave-guiding mirrors (FIG. 2) that is positioned and configured for receiving the beam of electromagnetic energy 6 from the microwave generator 16. The waveguide (e.g., system of mirrors) is also configured for emitting a guided and shaped beam of electromagnetic energy 6, with controlled phase and shape, into an antenna 57. It should be appreciated that the beam can be guided to an antenna 57 by either a dedicated mechanical waveguide or a system of mirrors, or a combination of the two. In this disclosure, such a system may be referred to as a waveguide, but it should be understood that any combination of the beam-guiding elements could be implemented so as to guide the beam to the antenna.

Each energy transmitter also comprises an antenna 57. The waveguide or a system of wave-guiding mirrors is positioned and configured for emitting the guided beam of electromagnetic energy 6 into the antenna 57, and the antenna 57 is positioned for receiving the guided beam of electromagnetic energy 6. In addition, the antenna 57 is configured for forming a directional beam of microwave energy 53, which may exhibit a controlled phase. In an exemplary embodiment, the control of the phase can be accomplished by varying the path-length of the beam by mechanical adjustment of the position of the wave-guiding mirrors, or the position of the secondary reflector 59 in a Cassegrain antenna 57. The directional beam of microwave energy 53 may also have controlled energy distribution properties achieved, for example, by controlling output of the microwave generator 16 (i.e., microwave emitter). To facilitate transmission of energy toward a mobile object, the antenna 57 may be a steerable antenna 57. In one exemplary embodiment, steering of the antenna 57 may be accomplished via a gimbal as illustrated in FIG. 2, in which steering is performed using motors 14 and 71 which rotate the antenna 57 system and the wave-guiding system of mirrors about axes 69 and 67. To further facilitate energy transmission for the use of a moving aerial vehicle, phases of the beams from multiple antennas may be controlled to produce energy maximum at the location of the vehicle.

A radome 9 is disposed about the antenna 57 of each energy transmitter. The radome 9 is configured for protecting the antenna 57 from aspects of the environment, such as wind, precipitation, and extreme temperatures. In addition, the radome 9 may be configured for absorbing side-lobe radiation produced by, or associated with, the directional beam of microwave energy 53 formed and emitted by the antenna 57. More specifically, the radome 9 may comprise a microwave absorbing material 3 disposed so as to absorb side-lobe components associated with the directional beam of microwave energy 53. In one exemplary embodiment, microwave absorbing material 3 may comprise loops of Teflon tubing with water flowing through the loops. The microwave absorbing material 3, comprising water or any other cooling fluid or gas, and the radome 9, may further comprise a cooling system configured for transferring thermal energy from the microwave absorbing material 3 to an external heat sink, such as a body of water or a reservoir with any other cooling material. Thus, the cooling system may comprise a system for circulating cooling material inside the radome 9, through one or more water loops. These and other features of the present invention provide enhanced safety. The heat captured inside the radome 9 could also be used to regenerate some of the energy which would normally be lost in the side-lobes.

A radome 9 serves an important function of side-lobe suppression allowing for safe operation of wireless energy transfer system. In a conventional antenna 57, energy radiated from the surface is typically distributed in a pattern with a main lobe 27, side lobes 32 and a back lobe 36. This would be undesirable from a safety and interference stand-point. Side-lobe suppressing radome 9 allows significant suppression of side lobes 32 and removal of the back lobe 36 as schematically depicted in FIG. 4.

Still further, the radome 9 may comprise an electromagnetically active structure 82 disposed and configured for facilitating control over one or more attributes of the directional beam of microwave energy 53. It should be appreciated that the aforementioned attribute may be directly related to one or more of: (1) a phase of the directional beam of microwave energy 53; (2) an energy distribution property of the directional beam of microwave energy 53; (3) a power level of the directional beam of microwave energy 53; (4) a primary direction of the directional beam of microwave energy 53; or (5) a combination of these attributes. The electromagnetically active structure of the radome 9 may comprise a system of dipoles embedded into otherwise transparent material or a meta-material introduced into otherwise transparent material of the radome 9 as depicted in FIG. 8.

Still further, the main reflector of the antenna 57 may comprise a system of dedicated dipoles configured for facilitating control over one or more attributes of the directional beam of microwave energy 53. The use of dipoles in the main reflector may be especially beneficial for controlling the phase of the beam and the distribution of side-lobes which will be guided into the microwave absorbing material 3 inside the radome 9.

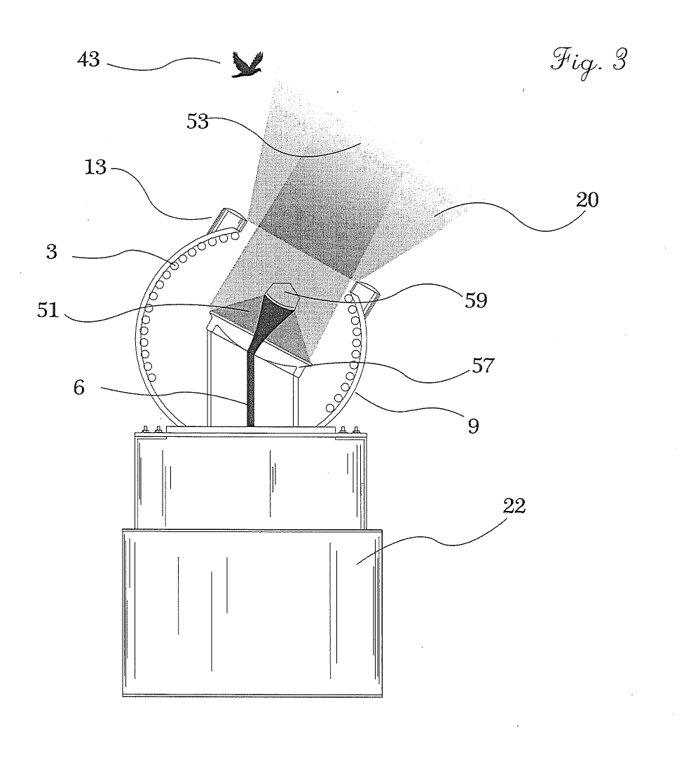

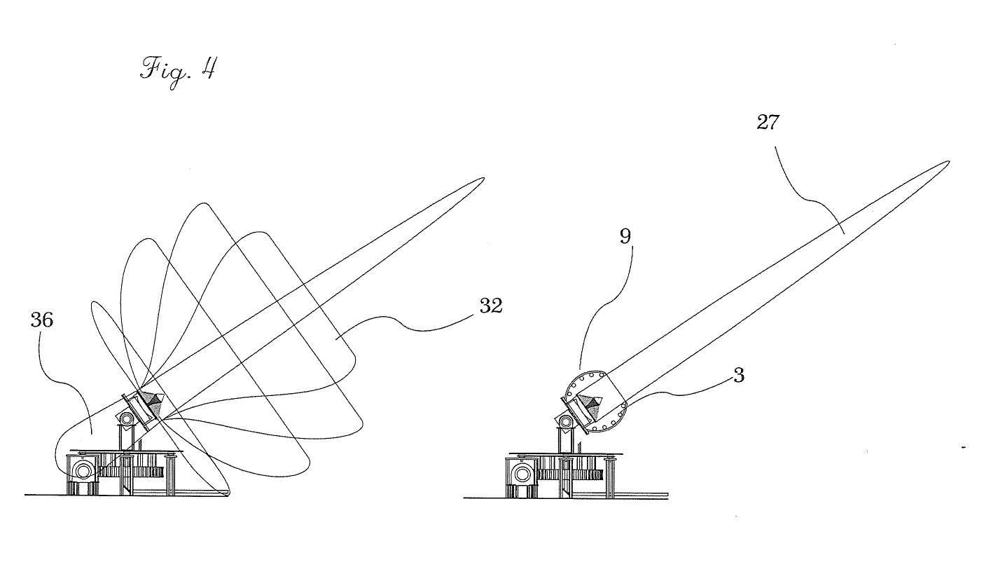

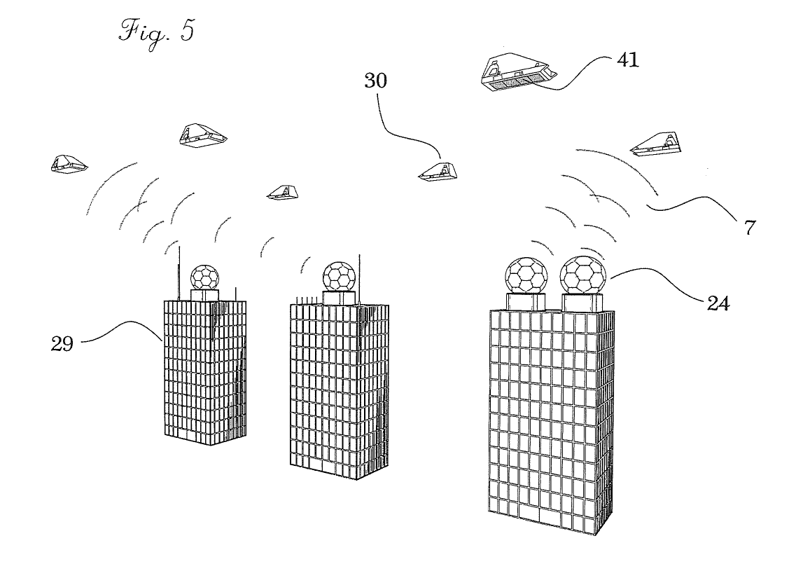

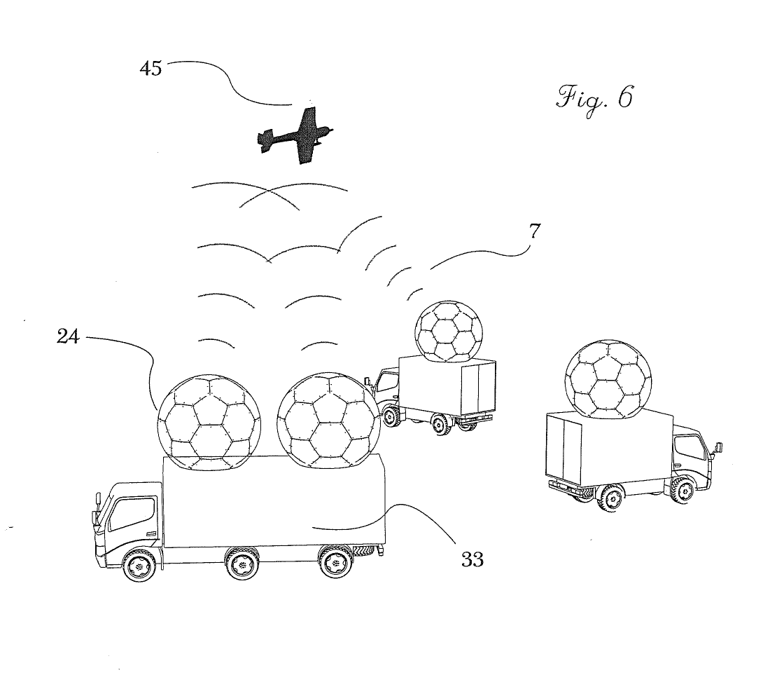

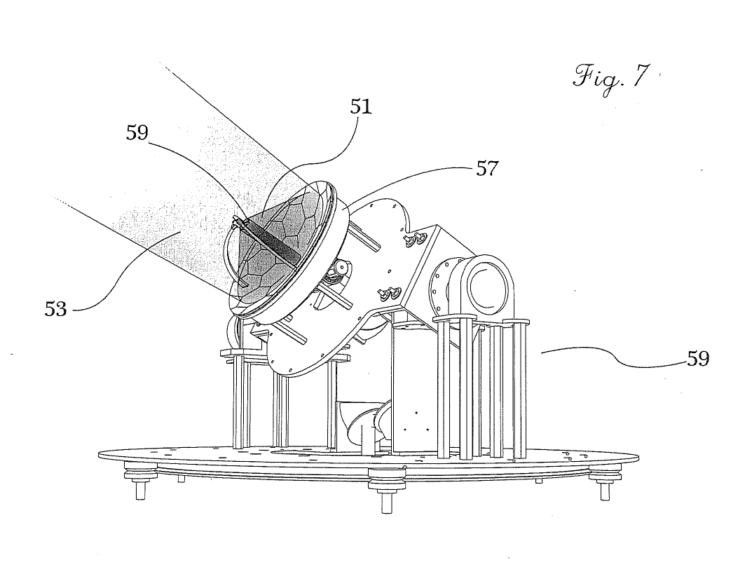

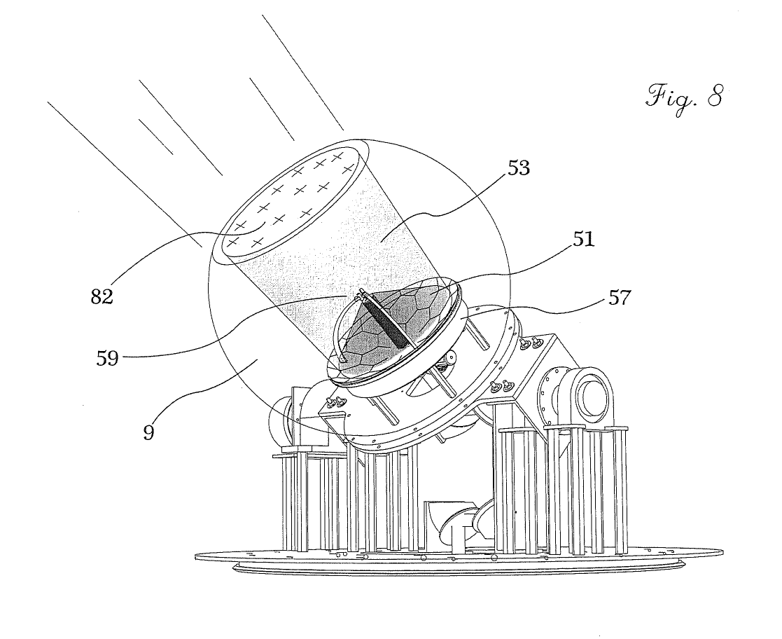

One or more optical sensors 13 (e.g., optical cameras 13 or infrared cameras 13) may be disposed in the radome 9 for monitoring the path of the directional beam of microwave energy 53 for interaction with foreign objects 43 (e.g., birds). It should be appreciated that the directional beam of microwave energy 53 has a primary direction along which the directional beam of microwave energy 53 is directed. Accordingly, the one or more optical sensors 13 or cameras 13 may be directed along the primary direction. The field of view 20 of optical sensors 13 or cameras 13 may be controlled in such a way as to fully enclose the microwave energy 53 beam as depicted in FIG. 3. Each optical sensor or camera may include a low-power, range-finding laser that is directed along the primary direction. Put another way, the laser may be oriented so as to be directed collinearly with the primary direction of the directional beam of microwave energy 53. The laser may be a low-power laser, range-finding laser, and the camera may be configured for monitoring a path of the directional beam of microwave energy 53, for determining whether an extraneous object has entered the path, and for facilitating a change in an attribute of the directional beam of microwave energy 53. An optical system and a range finding laser may be configured to terminate the microwave beam in the circumstance whenever an extraneous object (e.g., a bird) is seeing to approach the microwave beam.

A microwave energy receiver is disposed on an energy consuming device, and the energy consuming device is positioned remotely from the plurality of energy transmitters 24. The microwave energy receiver is configured for receiving the directional beam of microwave energy 53 from the system of energy transmitters 24 that comprise an array or from each individual energy transmitter of the plurality of energy transmitters 24. The energy consuming device may be configured for communicating a signal indicative of an energy requirement associated with the energy consuming device, with the signal being configured for reception by the controller 97 at the energy transmitting array or a single energy transmitter. It should be appreciated that the energy consuming device may be any remotely located device wherein configured for receiving a wireless transmission of electromagnetic energy 53. The transmission of energy in accordance with the invention is envisioned to be particularly advantageous when the energy consuming device is an aerial vehicle such as a multi-copter, an airplane 45, a space launch vehicle, any form of an autonomous flying vehicle 30, or any form of a piloted flying vehicle equipped with an energy receiving system. For example, energy receiving system could comprise a rectenna 41 designed to absorb microwave energy 53 and power an electric motor and/or charge a battery. In an exemplary embodiment, an energy receiving system could be a thermo-electric unit. In yet another exemplary embodiment, an energy receiving unit may be a heat exchanger coupled into a thermal thruster. The energy requirement associated with the energy consuming device being related to power necessary for propulsion of the energy consuming device or may be related to power necessary for recharging an energy storage device, or may be related to a combination of propulsion power and energy storage.

Thus, an energy requirement may be associated with the energy consuming device, and at least one attribute of each directional beam of microwave energy 53 may be modulated so that a coherent sum of energy received by the energy consuming device is approximately equal to or greater than the energy requirement associated with the energy consuming device. It should be appreciated that each energy transmitter of the plurality of energy transmitters 24 may be positioned at a known distance from each other energy transmitter thus forming a phased array with well-defined energy beaming properties. Knowledge regarding the spatial arrangement of the energy transmitters 24 may be useful for enabling the controller 97 to modulate attributes of the emitted beams so as to meet a desired constraint.

It should be appreciated that an ability to control special arrangement of the energy transmitters 24 could also be useful for specific applications. For example, in case of wireless energy transfer from a truck or trucks to a moving aerial vehicle depicted in FIG. 6, the distance between the trucks can be adjusted to either increase or decrease the separation of transmitters. A greater baseline distance between transmitters generally allows greater precision of wireless energy transfer, providing smaller size of the main lobe from the array, characterized by the divergence angel (θ) in accordance to the well-known optical law:

$$θ ∼ \frac{Wave lengt}{Separation between the emitters}$$

It should be appreciated that the controller 97 may be a central controller 97 as shown in FIG. 1, and/or could be a cloud-based controller 97, and/or could be a distributed controller 97 with each element of the array equipped with computing devices designed to communicate with one another either through a wired or wireless connection and configured to perform calculations needed for efficient energy transfer.

In an exemplary embodiment, the controller 97 is configured for modulating at least one attribute of the directional beam of microwave energy 53 of each energy transmitter of the plurality of energy transmitters 24 so that a coherent sum of energy received by the energy consuming device is approximately equal to or greater than the energy requirement associated with the energy consuming device. To meet such a constraint, a quantity of energy transmitted by the directional beam of microwave energy 53 of each individual energy transmitter of the plurality of energy transmitters 24 may be less than the energy requirement associated with the energy consuming device. Finally, the controller 97 may be configured for modulating at least one attribute of the directional beam of microwave energy 53 of each energy transmitter of the plurality of energy transmitters 24 so that a primary interference maxima produced by the directional beams 7 of microwave energy 53 produced by the plurality of energy transmitters 24 is positioned at the microwave energy receiver. In an exemplary embodiment, the controller 97 and the energy transmitters 24 are configured to meet these criteria associated with the position of the primary interference maxima with the energy consuming device being an aerial vehicle and even as the aerial vehicle moves through its flight trajectory.

An exemplary method for transmitting energy comprises receiving, by a plurality of microwave generators, each microwave generator 16 being associated with a respective one of the energy transmitters 24, electrical energy and emitting a beam of electromagnetic energy 6. The method also comprises receiving, by a waveguide or a system of wave-directing mirrors, the beam of electromagnetic energy 6 and emitting a guided beam of electromagnetic energy 6. The method further includes receiving, by an antenna 57, the guided beam of electromagnetic energy 6 and emitting, also by the antenna 57, and within a radome 9, a directional beam of microwave energy 53, with the directional beam of microwave energy 53 having a controlled attribute related to a phase and a controlled energy distribution property of the directional beam of microwave energy 53. The method also includes absorption of side lobes 32 of microwave energy 53, emitted by an antenna 57, in the microwave absorbing material 3 integrated into the structure of the radome 9. The method may also include monitoring of the environment around the active microwave beam of each energy transmitter of the array with optical sensors 13 (e.g., infrared cameras 13). Finally, the method includes modulating at least one attribute of the directional beam of microwave energy 53 of each energy transmitter of the plurality of energy transmitters 24.

Another exemplary method for transmitting energy comprises receiving, by a plurality of microwave generators, each microwave generator 16 being associated with one or more respective energy transmitters 24, electrical energy and emitting a beam of electromagnetic energy 6. In this embodiment, one high power energy generator could provide beam through a system of wave-guiding mirrors or wave-guides to one or more antennas enclosed in a side-lobe suppressing radome 9. In an alternative embodiment, energy from two or more microwave generators may be combined and directed through a system of waveguides or mirrors into an antenna 57.

In an exemplary embodiment, a method for transmitting energy may also include receiving, at a microwave energy receiver disposed on an energy consuming device that is located remotely from the plurality of energy transmitters 24, the directional beam of microwave energy 53 from each of the plurality of energy transmitters 24. An energy requirement may be associated with the energy consuming device, and at least one attribute of each directional beam of microwave energy 53 may be modulated so that a coherent sum of energy received by the energy consuming device is approximately equal to or greater than the energy requirement associated with the energy consuming device. The method may also include modulating at least one attribute of the directional beam of microwave energy 53 of each energy transmitter of the plurality of energy transmitters 24 so that a coherent sum of energy received by the energy consuming device is approximately equal to or greater than the energy requirement associated with the energy consuming device even though a quantity of energy transmitted by the directional beam of microwave energy 53 of each individual energy transmitter of the plurality of energy transmitters 24 is less than the energy requirement associated with the energy consuming device. Finally, a method for transmitting energy may include modulating at least one attribute of the directional beam of microwave energy 53 of each energy transmitter of the plurality of energy transmitters 24 so that a primary interference maxima produced by the directional beams of microwave energy 53 produced by the plurality of energy transmitters 24 is positioned at the microwave energy receiver.

Accordingly, exemplary embodiments of the system and method for transmitting energy provide a practical system and method for providing wireless energy transmission with improved safety, efficiency, and reliability. Exemplary embodiments provide improved methods for powering aerial vehicles using transmitted electromagnetic energy 53 as a source of power for propulsion while enhancing safety, reliability and efficiency. Still further, the invention provides for reliable steering of microwave antennas while reducing vibrations associated with wind and other environmental factors. As a result, concerns over inadvertent or undesirable emanations of electromagnetic radiation, particularly in undesired directions such as horizontally may be mitigated. The incorporation of safety-enhancing monitors, such as a system of optical sensors 13 (e.g., infrared cameras 13 and/or IR lasers), coupled with the ability to modulate attributes of the directional beam of microwave energy 53 (e.g., reduce the power of the beam or shut the beam off entirely), help to alleviate concerns that entrance of an extraneous object into the beam may cause undesirable damage to the extraneous object or other undesired consequences. Finally, exemplary embodiments of the invention enable practical and affordable means of powering aerial vehicles with sustainable sources of energy.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A system for transmitting energy comprising a controller operably coupled to a plurality of energy transmitters;
each of said plurality of energy transmitters comprising:
a microwave generator coupled to a source of electrical energy, the microwave generator configured for receiving electrical energy from the source of electrical energy and emitting a beam of electromagnetic energy;
a waveguide positioned for receiving the beam of electromagnetic energy from the microwave generator, the waveguide configured for receiving the beam of electromagnetic energy and emitting a guided beam of electromagnetic energy;
an antenna positioned for receiving the guided beam of electromagnetic energy, the antenna configured for forming a directional beam of microwave energy, the directional beam of microwave energy having a controlled phase, the directional beam of microwave energy having controlled energy distribution properties; and
a radome disposed about the antenna;
the controller configured for modulating an attribute of the directional beam of microwave energy of each energy transmitter of the plurality of energy transmitters.

2. A system for transmitting energy as described in claim 1, wherein the waveguide comprises a system of wave-guiding mirrors.

3. A system for transmitting energy as described in claim 1, wherein the waveguide is configured to control phase property of a guided beam.

4. A system for transmitting energy as described in claim 1, wherein the radome is configured to substantially remove side-lobe radiation.

5. A system for transmitting energy as described in claim 1, wherein the radome comprises one or more cameras for observation of an area surrounding the directional beam of microwave energy.

6. A system for transmitting energy as described in claim 1, further comprising a microwave energy receiver disposed on an energy consuming device that is located remotely from the plurality of energy transmitters and that is configured for receiving the directional beam of microwave energy from each of the plurality of energy transmitters.

7. A system for transmitting energy as described in claim 6, wherein an energy requirement is associated with the energy consuming device, at least one attribute of each directional beam of microwave energy being modulated so that a coherent sum of energy received by the energy consuming device is approximately equal to or greater than the energy requirement associated with the energy consuming device.

8. A system for transmitting energy as described in claim 7, wherein the controller is configured for modulating at least one attribute of the directional beam of microwave energy of each energy transmitter of the plurality of energy transmitters so that a coherent sum of energy received by the energy consuming device is approximately equal to or greater than the energy requirement associated with the energy consuming device, wherein a quantity of energy transmitted by the directional beam of microwave energy of each individual energy transmitter of the plurality of energy transmitters is less than the energy requirement associated with the energy consuming device.

9. A system for transmitting energy as described in claim 6, wherein the controller is configured for modulating at least one attribute of the directional beam of microwave energy of each energy transmitter of the plurality of energy transmitters so that a primary interference maxima produced by the directional beam of microwave energy produced by the plurality of energy transmitters is positioned at the microwave energy receiver.

10. A system for transmitting energy as described in claim 6, wherein the controller comprises a plurality of computing nodes, wherein each of said plurality of computing nodes is disposed on a respective one of said plurality of energy transmitters, and wherein each of said plurality of computing nodes is configured for communicating with at least one other one of said plurality of computing nodes.

11. A system for transmitting energy as described in claim 6, wherein the controller comprises a computing node disposed on a remote server.

12. A system for transmitting energy as described in claim 1, wherein the source of electrical energy is an electric grid.

13. A system for transmitting energy as described in claim 1, wherein the source of electrical energy is a stand-alone energy generator.

14. A system for transmitting energy as described in claim 1, wherein the source of electrical energy is a battery pack.

15. A system for transmitting energy as described in claim 1, wherein the source of electrical energy is a fuel cell pack.

16. A system for transmitting energy as described in claim 1, wherein the beam of electromagnetic energy has a controlled frequency.

17. A system for transmitting energy as described in claim 1, wherein the beam of electromagnetic energy has a controlled beam pattern.

18. A system for transmitting energy as described in claim 1, wherein the waveguide is positioned and configured for emitting the guided beam of electromagnetic energy into the antenna.

19. A system for transmitting energy as described in claim 1, wherein the antenna is a steerable antenna.

20. A system for transmitting energy as described in claim 19, wherein the steerable antenna is disposed on a gimbal.

21. A system for transmitting energy as described in claim 1, wherein the radome is configured for protecting the antenna from wind.

22. A system for transmitting energy as described in claim 1, wherein the radome is configured for protecting the antenna from precipitation.

23. A system for transmitting energy as described in claim 1, wherein the radome is configured for absorbing side-lobe components associated with the directional beam of microwave energy.

24. A system for transmitting energy as described in claim 1, wherein the radome comprises a microwave absorbing material disposed so as to absorb side-lobe components associated with the directional beam of microwave energy.

25. A system for transmitting energy as described in claim 24, wherein the microwave absorbing material comprises water.

26. A system for transmitting energy as described in claim 25, further comprising one or more microwave-transparent channels configured for facilitating a flow of the water through the one or more microwave-transparent channels.

27. A system for transmitting energy as described in claim 24, further comprising a cooling system configured for transferring thermal energy from the microwave absorbing material.

28. A system for transmitting energy as described in claim 27, wherein the cooling system comprises a system for circulating water about the radome through one or more water loops.

29. A system for transmitting energy as described in claim 1, wherein the radome comprises an electromagnetically active structure disposed and configured for facilitating control over one or more attributes of the directional beam of microwave energy.

30. A system for transmitting energy as described in claim 1, wherein the attribute is directly related to a phase of the directional beam of microwave energy.

31. A system for transmitting energy as described in claim 1, wherein the attribute of the directional beam of microwave energy is directly related to an energy distribution property of the directional beam of microwave energy.

32. A system for transmitting energy as described in claim 1, wherein the attribute is directly related to a power level of the directional beam of microwave energy.

33. A system for transmitting energy as described in claim 1, wherein the attribute is a primary direction of the directional beam of microwave energy.

34. A system for transmitting energy as described in claim 1, the radome further comprising an electromagnetically active structure.

35. A system for transmitting energy as described in claim 34, wherein the electromagnetically active structure comprises a meta-material.

36. A system for transmitting energy as described in claim 1, further comprising one or more cameras disposed in the radome.

37. A system for transmitting energy as described in claim 36, wherein the directional beam of microwave energy has a primary direction along which the directional beam of microwave energy is directed, the one or more cameras each comprising a laser that is directed along the primary direction.

38. A system for transmitting energy as described in claim 37, wherein the laser is oriented collinearly with the primary direction of the directional beam of microwave energy.

39. A system for transmitting energy as described in claim 37, wherein the laser is a low-power laser.

40. A system for transmitting energy as described in claim 37, wherein the laser is a range-finding laser.

41. A system for transmitting energy as described in claim 36, wherein the one or more cameras is configured for monitoring a path of the directional beam of microwave energy, for determining whether an extraneous object has entered the path, and for facilitating a change in an attribute of the directional beam of microwave energy.

42. A system for transmitting energy as described in claim 6, wherein the energy consuming device is configured for communicating a signal indicative of an energy requirement associated with the energy consuming device.

43. A system for transmitting energy as described in claim 6, wherein the energy consuming device is configured for communicating a signal indicative of a position and a velocity of the energy consuming device.

44. A system for transmitting energy as described in claim 6, wherein the energy consuming device is a moving aerial vehicle.

45. A system for transmitting energy as described in claim 42, wherein the energy requirement associated with the energy consuming device is related to power necessary for propulsion of the energy consuming device.

46. A system for transmitting energy as described in claim 42, wherein the energy requirement associated with the energy consuming device is related to power necessary for recharging an energy storage device.

47. A system for transmitting energy as described in claim 1, wherein the radome includes means for absorbing side lobes of an antenna, the radome with an optical system and infrared range finding lasers being capable of monitoring energy emitting area around microwave beam, the radome configured for modifying one or more properties of the beam.

48. A method for transmitting energy comprising:
receiving, by a plurality of microwave generators, each microwave generator being associated with a respective energy transmitter, electrical energy and emitting a beam of electromagnetic energy;
receiving, by a waveguide or a system of wave-guiding mirrors, the beam of electromagnetic energy and emitting a guided beam of electromagnetic energy;
receiving, by an antenna, the guided beam of electromagnetic energy,
emitting, by the antenna, within a radome, a directional beam of microwave energy, the directional beam of microwave energy having a controlled attribute related to a phase and a controlled energy distribution property of the directional beam of microwave energy;
absorbing energy from side lobes of the antenna in the radome as to avoid undesired microwave radiation,
protecting microwave with the radome, and
modulating at least one attribute of the directional beam of microwave energy of said respective energy transmitter.

49. A method for transmitting energy as described in claim 48, wherein the waveguide comprises a system of wave-guiding mirrors.

50. A method for transmitting energy as described in claim 48, further comprising receiving, at a microwave energy receiver disposed on an energy consuming device that is located remotely from the respective energy transmitter, the directional beam of microwave energy from each of the respective energy transmitter.

51. A method for transmitting energy as described in claim 48, the radome comprising an electromagnetically active structure, further comprising controlling at least one attribute of the directional beam of microwave energy of each energy transmitter of the respective energy transmitters.

52. A method for transmitting energy as described in claim 50, wherein an energy requirement is associated with the energy consuming device, and at least one attribute of each directional beam of microwave energy is modulated so that a coherent sum of energy received by the energy consuming device is approximately equal to or greater than the energy requirement associated with the energy consuming device.

53. A method for transmitting energy as described in claim 50, wherein an energy requirement is associated with the energy consuming device, wherein at least one attribute of each directional beam of microwave energy is modulated so that a coherent sum of energy is received by the energy consuming device, and wherein the energy consuming device communicates its position and energy requirement to a controller.

54. A method for transmitting energy as described in claim 53, further comprising modulating at least one attribute of the directional beam of microwave energy of each energy transmitter of the respective energy transmitter so that a coherent sum of energy received by the energy consuming device is approximately equal to or greater than the energy requirement associated with the energy consuming device, wherein a quantity of energy transmitted by the directional beam of microwave energy of each individual energy transmitter of the respective energy transmitter is less than the energy requirement associated with the energy consuming device.

55. A method for transmitting energy as described in claim 50, further comprising modulating at least one attribute of the directional beam of microwave energy of each energy transmitter of the respective energy transmitter so that a primary interference maxima produced by the directional beam of microwave energy produced by the respective energy transmitter is positioned at the energy consuming device.
